(19) United States
(12) Patent Application Publication
(10) Pub. No.: US 2024/0092129 A1
(43) Pub. Date: Mar. 21, 2024

(54) WATERPROOF UAV FOR CAPTURING IMAGES

(71) Applicants: Sharon Moll, Wetzikon (CH); Dawei Zhang, Seattle, WA (US)

(72) Inventors: Sharon Moll, Wetzikon (CH); Dawei Zhang, Seattle, WA (US)

(21) Appl. No.: 17/944,856

(22) Filed: Sep. 14, 2022

(51) Int. Cl. B60F 5/00; B63G 8/00; B64C 39/02

(52) U.S. Cl. CPC B60F 5/003; B63G 8/001; B64C 39/024; B63G 2008/004

(57) ABSTRACT

A waterproof UAV that records camera footage while traveling through air and while submerged in water. The UAV alters speed and direction of propellers dependent on the medium that the UAV is traveling through to provide control of the UAV. The propellers are capable of spinning in both directions to enable the UAV to change its depth and orientation in water. A machine learning (ML) model is used to identify humans and objects underwater. A housing coupled to the UAV makes the UAV positively buoyant to float in water and to control buoyancy while submerged.

### TECHNICAL FIELD

The present disclosure generally relates to unmanned aerial vehicles (UAVs).

### BACKGROUND

UAVs, including drones, are aircraft without a human pilot aboard. Conventional drones have various configurations (e.g., multiple rotors), a camera and a global positioning system (GPS). Multirotor drones are able to capture images during flight using the camera.

### BRIEF DESCRIPTION OF THE DRAWINGS

In the drawings, which are not necessarily drawn to scale, like numerals may describe similar components in different views. Like numerals having different letter suffixes may represent different instances of similar components. The several figures depict one or more implementations and are presented by way of example only and should not be construed as limiting. Included in the drawing are the following figures:

FIG. 1A is a perspective view of a UAV;

FIG. 1B is perspective view of the UAV of FIG. 1A encompassed by a housing to provide buoyancy;

FIG. 2 is a block diagram of a control system configured to automatically control the UAV;

FIG. 3 is an illustration of a flight path FP1 that routes the UAV;

FIG. 4 is an illustration of another flight path FP2 that routes the UAV;

FIG. 5 is an illustration of another flight path FP3 that routes the UAV in the air and underwater;

FIG. 6 is an illustration of the UAV following a diver underwater; and

FIG. 7 is flowchart of a method of operating the UAV in the air and underwater.

### DETAILED DESCRIPTION

A waterproof UAV that records camera footage while traveling through air and while submerged in water. The UAV alters speed and direction of propellers dependent on the medium that the UAV is traveling through to provide control of the UAV. The propellers are capable of spinning in both directions to enable the UAV to change its depth and orientation in water. A machine learning (ML) model is used to identify humans and objects underwater. A housing coupled to the UAV makes the UAV positively buoyant to float in water and to control buoyancy while submerged.

Additional objects, advantages and novel features of the examples will be set forth in part in the description which follows, and in part will become apparent to those skilled in the art upon examination of the following and the accompanying drawings or may be learned by production or operation of the examples. The objects and advantages of the present subject matter may be realized and attained by means of the methodologies, instrumentalities and combinations particularly pointed out in the appended claims.

The description that follows includes systems, methods, techniques, instruction sequences, and computing machine program products illustrative of examples of the disclosure. In the following description, for the purposes of explanation, numerous specific details are set forth in order to provide an understanding of various examples of the disclosed subject matter. It will be evident, however, to those skilled in the art, that examples of the disclosed subject matter may be practiced without these specific details. In general, well-known instruction instances, protocols, structures, and techniques are not necessarily shown in detail.

The terms and expressions used herein are understood to have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” “includes,” “including,” or any other variation thereof, are intended to cover a non-exclusive inclusion, such that a process, method, article, or apparatus that comprises or includes a list of elements or steps does not include only those elements or steps but may include other elements or steps not expressly listed or inherent to such process, method, article, or apparatus. An element preceded by “a” or “an” does not, without further constraints, preclude the existence of additional identical elements in the process, method, article, or apparatus that comprises the element.

The term “coupled” as used herein refers to any logical, optical, physical or electrical connection, link or the like by which signals or light produced or supplied by one system element are imparted to another coupled element. Unless described otherwise, coupled elements or devices are not necessarily directly connected to one another and may be separated by intermediate components, elements or communication media that may modify, manipulate or carry the light or signals.

Reference now is made in detail to the examples illustrated in the accompanying drawings and discussed below.

Commercial UAVs typically include a camera for imaging the earth and other objects below, for instance, capturing still images and video. In some versions, the camera is fixed to the UAV, without the use of a gimbal for selectively positioning the camera. More complicated UAVs include an electronic receiver and an electronically configurable gimble and camera. A remotely located controller establishes a wireless link with the receiver of the UAV to control the UAV and the camera. The electronic receiver, electrically controllable gimbles, and cameras are expensive, fragile, and mechanically complex, and add to the weight and bulkiness of the UAV. The UAV described herein is smaller and more lightweight than conventional UAVs. Additionally, the UAV has continuous surfaces and is sized to facilitate placement in a pocket of a garment.

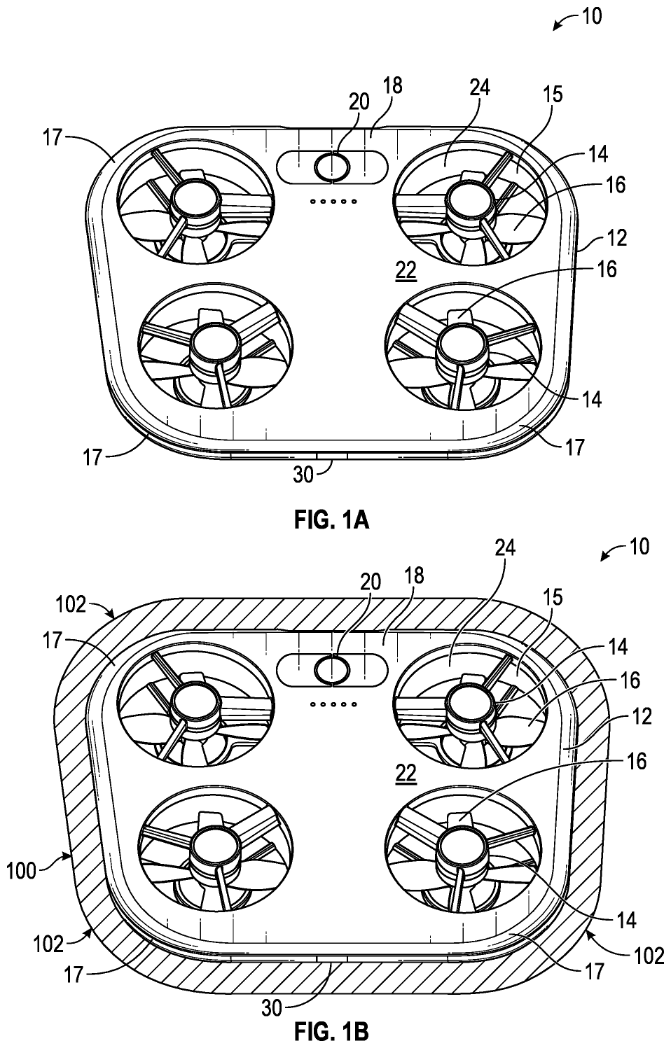

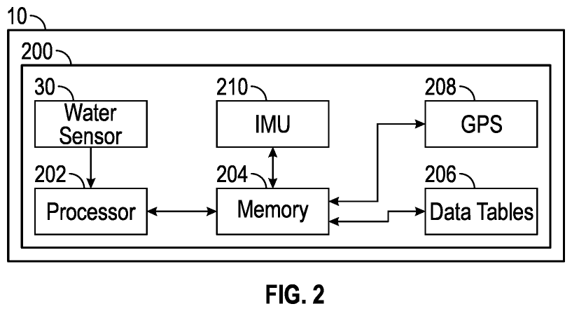

FIG. 1A is a perspective view of a UAV 10 having a shroud 12 with propeller openings 15 extending through the shroud 12. Propellers 14 are positioned in respective propeller openings 15. The shroud 12 includes a rectangular lower surface 18 and a rectangular upper surface (not shown) with a smooth continuous edge 17 extending around the entire UAV 10 between the upper and lower surfaces. The shroud encompasses electronics (e.g., processor 202, memory 204, GPS receiver 208, and IMU 210; FIG. 2) and structural components of the UAV 10 (e.g., camera 20). In the illustrated example, the rectangular surfaces completely encompass the propellor openings 15.

Each propeller opening 15 extends through the shroud 12 from the upper surface to the lower surface 18 and includes a continuous wall 24 extending around a periphery of the propeller opening 15. Although four propeller openings 15 with respective propellers 14 are shown and described, more or fewer propeller openings 15 with respective propellers may be present. As used herein, the term continuous wall means a wall with a surface free of any visually perceptible through holes.

Each propeller 14 includes multiple blades 16. Each blade 16 is made out of metal or a non-conductive material. Typically, non-conductive materials, such as plastic, are used for the blades since they are generally lighter.

The shroud 12 has a smooth continuous surface 22 and the peripheral edges 17 are also smooth. The shroud 12 is sized such that the UAV 10 can fit in a garment (e.g., a pocket of pants or a jacket). The peripheral edges 17 are rounded to facilitate placement of the UAV 10 into a garment pocket. The smooth continuous surface 22 and peripheral edges 17 also provide an elegant aesthetic design. As used herein, the term smooth continuous surface means free of any visually perceptible through holes or sharp edges.

A camera 20 is positioned adjacent the lower surface 18 of the shroud 12. The camera 20 faces outward from the lower surface 18 and is configured to capture images at a fixed pitch angle with respect to the shroud 12. In this example, the camera 20 is facing downward from the shroud 12 such that the camera pitch angle is 90 degrees with respect to the lower surface 18. In other examples, the camera pitch angle can also be fixed at other pitch angles, such as −5 degrees downward from horizontal, or other pitch angles as desired.

The UAV 10 is waterproof for a sustained submersion underwater. The shroud 12 is waterproofed by sealing all edges, openings, and gaps of the shroud 12. The motors of the propellers 14 may also be waterproof and capable of operating underwater. In one example, the waterproofing is done by sealing all edges with an epoxy coating to provide moisture protection of the internal electronics of the UAV 10 including the control system 200 as shown in FIG. 2. The UAV 10 is waterproof to support full immersion for extended periods of time. In one example, the UAV 10 has an industry standard waterproof rating of IP68.

FIG. 1B is a perspective view of the UAV 10 having a separate housing 100 that is attached to the shroud 12 (either permanently or selectively). The separate housing 100 has corners 102 that are commensurate with the corners 17 of the UAV 10. In one example, the UAV 10 by itself is not buoyant in water and the separate housing 100 is attached to the UAV 10 to provide a positively buoyant UAV 10. An upwards buoyant force generated by the housing 100 is only slightly higher than the gravitational force of the UAV 10 so that the UAV 10 requires minimal power, for example, minimal propellor 14 rotations, to stay at a particular depth. The UAV 10 is positively buoyant for a scenario when power is lost to the UAV 10 while underwater.

In one example, the separate housing 100 is a hollow case that partially encompasses the UAV 10 about a periphery of the shroud 12 while exposing the propellers 14 so that they can function normally. In one example, the hollow case consists of top and bottom shells each formed as rings that can be snapped together to secure the housing 100 to the shroud 12. In another example, the top and bottom shells can be connected via a hinge. Additionally, the case may completely or partially cover the top surface (not shown) of the UAV 10 and the bottom surface 18 of the UAV 10 while exposing the propellor openings 15 so as to not inhibit operation of the propellers 14. In another example, the separate housing 100 may be a foam case, such as a closed cell foam, that can be coupled to the outside of the UAV 10 via friction. The separate housing 100 can be removed from the shroud 12 when not used for underwater purposes to reduce weight of the UAV 10. The separate housing 100 allows the UAV 10 to float within a reasonable depth of water that is suitable for recreational applications.

A water sensor 30 is positioned adjacent the lower surface 18 of the shroud 12 to determine if the UAV 10 is in water. The water sensor 30 is used by the processor 202 as shown in FIG. 2 to configure the UAV 10 between modes, e.g., an aerial mode and a water mode. The processor 202 in the aerial mode configures the propellers 14 to operate at speeds for effective navigation through air, whereas the processor 202 in the water mode configures the propellers 14 to operate at slower speeds to accommodate for the greater density of water as compared to air. When the UAV 10 is operating in water, the UAV 10 opposes its buoyant force when maneuvering. The buoyant force is in the opposite direction of gravity, which the UAV 10 opposes when operating in the air. The processor 202 in the water mode accounts for this change by altering the direction that the propellers 14 spin for maintaining a specific depth. In one example, the UAV 10 operates aerially and the water sensor 30 communicates to the processor 202 the absence of water. The UAV 10 then lands on the surface of a body of water and the water sensor 30 communicates to the processor 202 the presence of water and the UAV 10 switches to the water mode to better navigate underwater. In another example, the water sensor 30 may be absent and the switching between aerial and water modes may be done by a user.

The propellers 14 each have the independent ability to spin in both directions in the water mode to maneuver the UAV 10 in the x/y plane and an orthogonal z direction, with z being depth to provide 3-dimensional (3D) control, such as deeper or shallower in water and laterally, depending on the individual spin directions. The direction of each propeller rotation is controlled by the processor 202. In one example, independent switches may be provided for each propeller that are controlled by the processor 202 to control a direction of the propeller rotation. In one example, the two left propellers 14 shown in FIG. 1A can spin in the opposite direction while the right propellers 14 spin in the opposite direction of the two left propellers 14 to tilt the UAV 10. Once the UAV 10 is tilted a desired rotation, such as 90°, and the UAV 10 is facing the target, all propellers 14 can spin into the same direction to move the UAV 10 toward or away from the target. Different propeller 14 speeds between each propeller 14 are used to enable the UAV 10 to turn and support additional directional actions. This maneuverability is useful for various cinematic footage techniques such as panorama, fade-out, etc., both in the air and in the water.

FIG. 2 illustrates a control system 200 configured to automatically control the UAV 10, including UAV operation along a flight path (FP). The control system 200 includes an electronic processor 202 comprising a flight controller, a memory 204 including flight plans, instructions and code for operating processor 202 to control and operate the UAV 10, data tables 206 stored in memory 204, a global positioning system (GPS) receiver 208 providing global positioning of the UAV 10, an inertial measurement unit (IMU) 210, and the water sensor 30. The electronic processor 202 establishes the FP of the UAV 10 based on performance data in data tables 206 and the GPS 208. Multiple FPs are stored in memory 204, wherein the FPs can be custom programmed and downloaded by into memory 204 by a user of the UAV 10 wirelessly or by a cable.

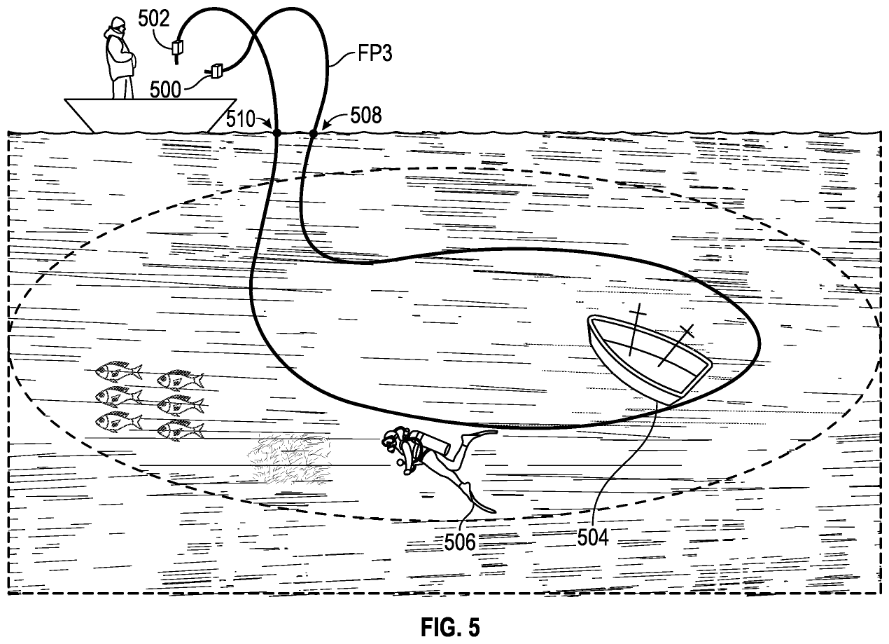

In the instance that connection with the GPS 208 is disrupted, the IMU 210 is used by the processor 202 to estimate the position of the UAV 10 until the GPS 208 is reconnected. For example, when the UAV 10 follows a flightpath FP3 as shown in FIG. 5 from an aerial path to an underwater path, the GPS connection of the UAV becomes disrupted. The processor 202 uses measurements from the IMU 210 to estimate the position of the UAV 10 to continue following the FP3 until the GPS 208 becomes reconnected.

The processor 202 receives signals from the water sensor 30 to determine if the UAV 10 is in water. The processor 202 is configured to operate the UAV 10 in the aerial mode or the water mode depending on the sensor signals from the water sensor 30. The processor 202 controls the propellers 14 at different speeds and directions dependent on the mode and movement controls of the UAV 10.

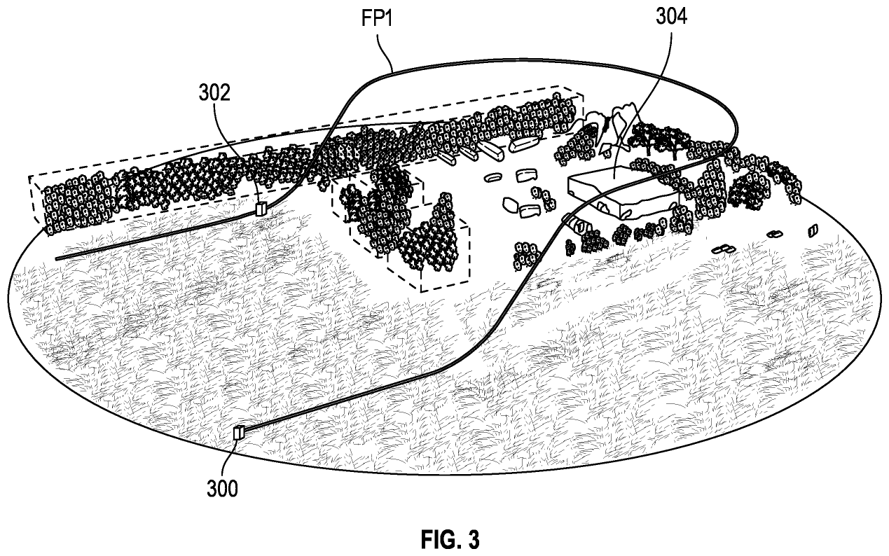

FIG. 3 illustrates a graphical representation of a flight path FP1 that routes the UAV 10 from a starting position 300 to an end position 302. The FP1 routes the UAV 10 along a smooth path at varying altitudes to a target(s) 304, also referred to as a point of interest (POI). The target 304 can comprise of many features including buildings, trees, people etc. The limited or restricted spacing around the target 304 constrains and may limit the maneuvering of the UAV 10 about target 304, and thus the camera imaging. This spacing creates difficulty for the UAV 10 having a fixed position camera 20.

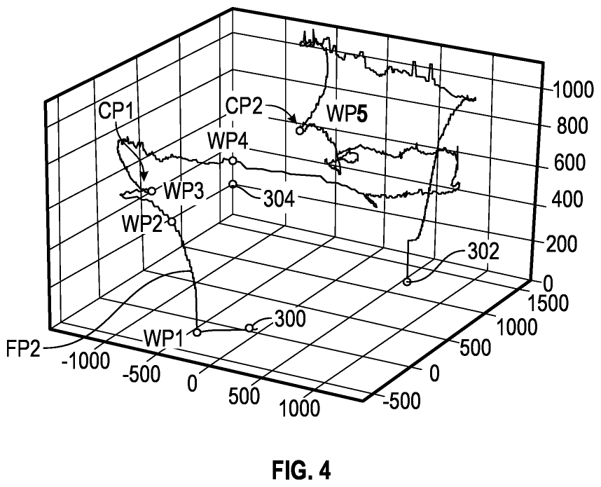

FIG. 4 illustrates a graphical representation of a more complex flight path FP2 that the UAV 10 traverses to and about target 304. The flight path FP2 includes multiple waypoints WP and multiple image capture points including image capture points CP1 and CP2. The flight path FP2 also includes performance variables of the UAV 10, and the orientation of the UAV 10 including a pitch angle PA of the camera 20 with respect to horizontal at each waypoint, including proximate the image capture points CP1 and CP2. In this example, the UAV 10 traverses the flight path FP2 having multiple waypoints to image capture point CP1 proximate the target 304.

In an example, the flight path FP2 orients the UAV 10 such that the camera 20 is directed at a pitch angle PA3 facing target 304 when approaching, and at, image capture point CP1. The camera 20 captures images of target 304 at image capture point CP1 for a predetermine image capture time and stores the images in memory 204. The UAV 10 subsequently traverses flight path FP2 to image capture point CP2 proximate target 304. The flight path FP2 also orients the UAV 10 such that the camera 20 is directed downwardly at a pitch angle PA5 toward target 304. The camera 20 again captures images at image capture point CP2 and stores the images in memory 204.

Since the camera 20 is fixed to shroud 12 at the fixed pitch angle, orienting the UAV 10 in a predetermined stable position at an angle is not an ordinary task. More importantly, establishing a predetermined camera angle of the camera 20 relative to the target 304 at capture points CP1 and CP2, is not an ordinary task. The flight paths are automatically determined by electronic processor 202 based upon the GPS position of the capture points CP1 and CP2, and the desired camera pitch angle at capture points CP1 and CP2. The processor 202 determines the operational parameters of the UAV 10, and it takes into account the weight and flight performance of the UAV 10. The determined flight paths increase the image capture time at capture points CP1 and CP2, at the desired pitch angle, which is very beneficial for imaging.

FIG. 5 illustrates a graphical representation of a flight path FP3 that routes the UAV 10 from a starting position 500 above water on a path that travels under water to an end position 502 above water. The UAV 10 is configured to capture images and/or video along the flight path. The FP3 routes the UAV 10 along a flight path that transitions from the air to underwater at transition point 508 where the UAV 10 is switched from the aerial mode to the water mode. The FP3 routes the UAV 10 along a smooth path that varies in underwater depth to targets 504 and 506, also referred to as a point of interest (POI). The targets 504 and 506 can include many features including coral, shipwrecks, underwater structures, aquatic life, divers, etc. The UAV 10 then exits the water at the transition point 510 and returns to the aerial mode to fly back into the air to the end position 502 out of water.

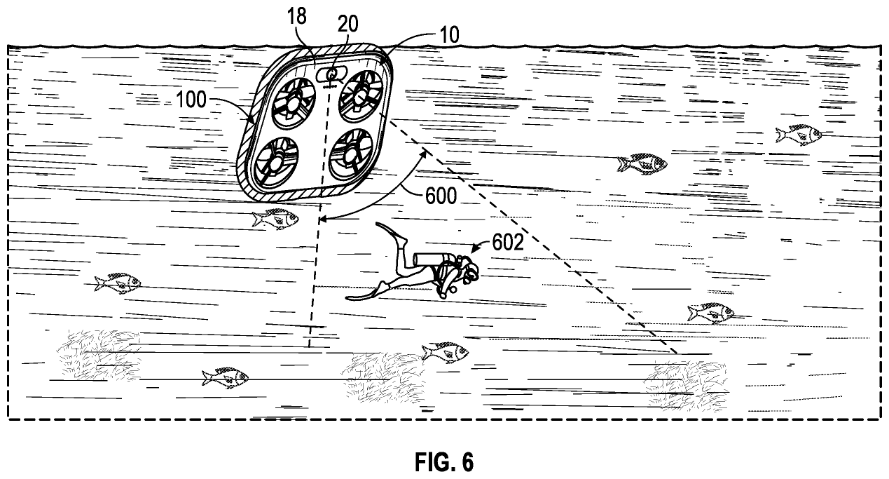

FIG. 6 illustrates the UAV 10 capturing images and video underwater while following a target, wherein the target is a diver 602. In one example, the camera 20 has a view 600 that encompasses the diver 602, and the processor 202 is configured to control the UAV 10 to autonomously follow the diver 602 to keep the diver 602 within the view 600 of the camera 20 by individually controlling the propellors 14. The processor 202 controls the speed and direction of the propellors 14 to maneuver the UAV 10. The processor 202 employs existing face-detection algorithms with a machine learning model to better detect humans, divers, and objects underwater.

In another example, the UAV 10 is configured to be manually controlled remotely by a user using a remote control. The user can manually switch the UAV 10 between the aerial mode and water mode, and to operate the UAV 10 both in the air and underwater. A live video generated by the camera 20 is also transmitted from the UAV 10 to the user.

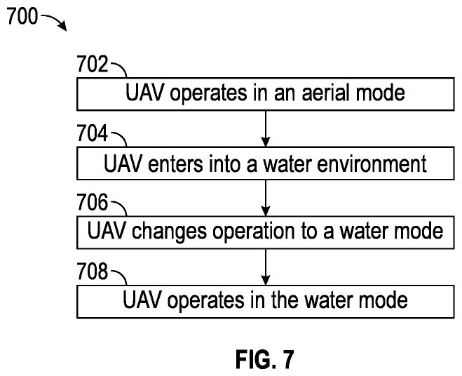

FIG. 7 illustrates a method 700 of operating the UAV 10 in both an aerial mode and a water mode.

At block 702, the UAV 10 is operating in the aerial mode. The UAV 10 may fly autonomously or be flown and controlled by a remote user. The UAV 10 is configured to maneuver and navigate through the air. Operation of the UAV 10 in the air may include capturing aerial footage using the camera 20.

At block 704, the UAV 10 enters a water environment. For example, the UAV 10 lands on the surface of a body of water.

At block 706, the UAV 10 changes its operating mode from the aerial mode to the water mode. The change may be done automatically via communication between the water sensor 30 and the processor 202 or may be done by a remote user. The UAV 10 is configured to maneuver and navigate underwater.

At block 708, the UAV 10 operates in the water mode. The UAV 10 may maneuver autonomously or be controlled by a remote user. Operation of the UAV 10 underwater may include capturing underwater footage using the camera 20.

In addition, in the foregoing Detailed Description, it can be seen that various features are grouped together in various examples for the purpose of streamlining the disclosure. This method of disclosure is not to be interpreted as reflecting an intention that the claimed examples require more features than are expressly recited in each claim. Rather, as the following claims reflect, the subject matter to be protected lies in less than all features of any single disclosed example. Thus, the following claims are hereby incorporated into the Detailed Description, with each claim standing on its own as a separately claimed subject matter.

The examples illustrated herein are described in sufficient detail to enable those skilled in the art to practice the teachings disclosed. Other examples may be used and derived therefrom, such that structural and logical substitutions and changes may be made without departing from the scope of this disclosure. The Detailed Description, therefore, is not to be taken in a limiting sense, and the scope of various examples is defined only by the appended claims, along with the full range of equivalents to which such claims are entitled.

What is claimed is:

1. An unmanned aerial vehicle (UAV), comprising:
a waterproof shroud;
a propeller opening extending through the waterproof shroud;
a propeller coupled to the waterproof shroud and positioned within the propeller opening;
a housing coupled to the waterproof shroud and configured to buoy the UAV in water; and
a processor disposed in the waterproof shroud; the processor configured to operate the UAV in a first mode comprising navigating the UAV through air, and in a second mode comprising navigating the UAV underwater.

2. The UAV as specified in claim 1, wherein the housing is selectively attachable to the shroud.

3. The UAV as specified in claim 2, wherein the housing is a hollow case.

4. The UAV as specified in claim 3, wherein the housing encompasses an outer edge of the waterproof shroud.

5. The UAV as specified in claim 1, further comprising a water sensor, wherein the processor is configured to switch the UAV between the two modes based on signals received from the water sensor.

6. The UAV as specified in claim 1, further comprising a plurality of the propellers, wherein each of the propellers is configured to be controlled independently by the processor in speed and direction.

7. The UAV as specified in claim 6, wherein the UAV further comprises a camera configured to capture images and video.

8. The UAV as specified in claim 7, wherein the processor is configured to use a machine learning algorithm to detect a target underwater when the UAV is in the second mode.

9. The UAV as specified in claim 8, wherein the UAV is configured to autonomously follow the target underwater.

10. The UAV as specified in claim 7, further comprising a global positioning system (GPS) coupled to the shroud, an inertial measurement unit (IMU), and a memory containing a flight path.

11. The UAV as specified in claim 10, wherein the flight path includes a plurality of waypoints.

12. The UAV as specified in claim 11, wherein the GPS and IMU are configured to be used to navigate the UAV between the plurality of waypoints.

13. A method of capturing images using an unmanned aerial vehicle (UAV) comprising a waterproof shroud, a processor disposed in the waterproof shroud, a propeller opening extending through the waterproof shroud, a propeller coupled to the waterproof shroud and positioned within the propeller opening, a housing coupled to the waterproof shroud and configured to buoy the UAV in water, the method comprising:
operating the UAV in a first mode comprising navigating the UAV through air;
switching the UAV from the first mode to a second mode; and
operating the UAV in the second mode comprising navigating the UAV underwater.

14. The method as specified in claim 13, wherein the housing is selectively attachable to the shroud.

15. The method as specified in claim 14, wherein the UAV further comprises a camera, the method further comprising capturing images using the camera.

16. The method as specified in claim 13, further comprising a water sensor, wherein the processor switches the UAV between the two modes based on signals received from the water sensor.

17. The method as specified in claim 13, further comprising a plurality of propellers, wherein each of the propellers are controlled independently by the processor in speed and direction.

18. The method as specified in claim 13, wherein the processor uses a machine learning algorithm to detect a target underwater when the UAV is in the second mode and autonomously following the target underwater.

19. The method as specified in claim 13, the UAV further comprising a global positioning system (GPS) coupled to the shroud, an inertial measurement unit (IMU), and a memory containing a flight path including a plurality of waypoints, wherein the step of navigating the UAV underwater further comprises using the GPS and IMU to navigate the UAV between the plurality of waypoints.

20. A non-transitory computer readable medium storing program code which, when executed, is operative to cause an electronic processor of an unmanned aerial vehicle (UAV) comprising a waterproof shroud, a processor disposed in the waterproof shroud, a propeller opening extending through the waterproof shroud, a propeller coupled to the waterproof shroud and positioned within the propeller opening, a housing coupled to the waterproof shroud configured to buoy the UAV in water, to perform the steps of:
operating the UAV in a first mode comprising navigating the UAV through air;
switching the UAV from the first mode to a second mode; and
operating the UAV in the second mode comprising navigating the UAV underwater.
